(19) United States
(12) Patent Application Publication
(10) Pub. No.: US 2007/0039985 A1
(43) Pub. Date: Feb. 22, 2007

(54) Roof rack concept for passenger vehicles, incorporating reconfigurable, multipurpose storage roof for improved aerodynamics and aesthetics

(76) Inventors: Charles Warren, Sarver, PA (US); Todd L. Summe, Pittsburgh, PA (US); Miloslav Novak, Glenshaw, PA (US); John Cobes, Lower Burrell, PA (US); Thomas M. Kubilius, Mt. Lebanon, PA (US); Zachary B. Beard, Port Matilda, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/506,154

(22) Filed: Aug. 17, 2006

Related U.S. Application Data
(60) Provisional application No. 60/709,746, filed on Aug. 19, 2005.

(51) Int. Cl. B60R 9/00

(52) U.S. Cl. 224/321; 224/326

(57) ABSTRACT

The present invention provides a roof rack including at least two forward recesses and at least two rear recesses within a roof panel; a vertically extending stanchion in each of at least two forward and rear recesses, a forward transverse recess starting at one forward recess and ending at an opposite forward recess; a forward transverse bar in said transverse recess having pivoting connections with said vertically extending stanchions; a rear transverse recess starting at one rearward recess and ending at an opposite rearward recess; and a rear transverse bar in said transverse recess having pivoting connections with said vertically extending stanchions in each of said at least two rear recesses, wherein said each of said rear transverse bar and said forward transverse bar having a stored position with a vertical height below an upper surface of said roof panel and a deployed position above said upper surface of said roof panel.

### CROSS REFERENCE TO RELATED APPLICATION

The present invention claims the benefit of U.S. provisional patent application 60/709,746 filed Aug. 19, 2005 the entire contents and disclosure of which is incorporated by reference as is fully set forth herein.

### FIELD OF THE INVENTION

The invention relates generally to vehicle cargo racks, more particularly, to pop-up roof racks being stored within the roof panel when not deployed.

### BACKGROUND OF THE INVENTION

Typically, automotive roof racks are rigidly mounted in a fixed position on the roof of a motor vehicle. Conventional roof racks suffer from many problems. Often, permanently fixed roof racks are bulky and somewhat unsightly, which can detract from the aesthetics of the vehicle and increase the wind resistance of the roof-line and may cause wind-induced noise. Moreover, some roof racks can be damaged and difficult to clean when passing through automatic car washes and the like (e.g., similar to large spoilers and powered antennas), which can restrict a car owner's ability to wash and wax his or her car.

Removable roof racks, especially commonly available aftermarket add-ons, also suffer from many problems. While removable roof racks can be taken off, they are often difficult to install and remove. Often, several straps, hooks, snaps, clamps and other fasteners are used to securely fasten the roof rack to the vehicle, which may take considerable time to set up and may be difficult for an individual to perform alone. Furthermore, fasteners can scratch, dent, or otherwise damage the underlying paint or body panel, which can lead to accelerated corrosion, and generally detracts from the vehicle's appearance.

Thus, a need exists for an aesthetically pleasing vehicle cargo rack that extends above the vehicles roofline when in a deployed position and is stored within the car's roof panel when not deployed.

### SUMMARY OF THE INVENTION

One aspect of the present invention is a roof rack system that extends above the roof panel of the vehicle when in a deployed position and is collapsible within the roof panel to provide a continuous roofline profile when in a stored position. Broadly, the present roof rack includes:
at least two forward recesses and at least two rear recesses within a roof panel;
vertically extending stanchions in each of said at least two forward recesses and said at least two rear recesses;
a forward transverse channel starting at one forward recess and ending at an opposite forward recess;
a forward transverse bar extendably positioned in said forward transverse channel having pivoting connections with said vertically extending stanchions in each of said at least two forward recesses;
a rear transverse channel starting at one rearward recess and ending at an opposite rearward recess; and
a rear transverse bar extendably positioned in said rear transverse channel having pivoting connections with said vertically extending stanchions in each of said at least two rear recesses, wherein said each of said rear transverse bar and said forward transverse bar having a stored position with a vertical height below an upper surface of said roof panel and a deployed position above said upper surface of said roof panel.

In one embodiment of the present invention, the forward transverse bar and the rear transverse bar have a fixed length. In another embodiment, the forward transverse bar and said rear transverse bar are constructed of a telescoping assembly that extends to a first length when the roof rack is in the deployed position and retracts to a second length when the roof rack is in a stored position.

In one embodiment, the forward transverse bar and the rear transverse bar have an upper surface that is aligned to a contour of the upper surface of the vehicle's roof panel when the forward transverse bar and the rear transverse bar are in the stored position. In a further embodiment, a cover is hingeably attached to the vehicle's roof panel and is positioned to maintain the contour of the upper surface of the vehicle's roof panel when the forward transverse. bar and rear transverse bar are in the stored position. In one embodiment, the roof rack system is actuated by a motor that is in communication to each vertically extending stanchion through an endless cable. In one embodiment, a unitary forward channel provides the forward recesses and the forward transverse channel, and a unitary rear channel provides the rear recesses and the rear transverse channel.

In another aspect of the present invention, a roof rack is provided having detachable transverse bars for supporting cargo. Broadly, the roof rack includes:
at least two forward recesses and at least two rear recesses within a roof panel;
a vertically extending stanchion in each of said at least two forward recesses and said at least two rear recesses; wherein said each of said vertically extending stanchions having a stored position with a vertical height below an upper surface of said roof panel and a deployed position above said upper surface of said roof panel;
a forward transverse bar detachably connected to the vertically extending stanchions in the at least two forward recesses when in the deployed position; and
a rear transverse bar detachably connected to the vertically extending stanchions in the at least two rear recesses when in the deployed position.

### BRIEF DESCRIPTION OF THE DRAWINGS

A full understanding of the invention can be gained from the following description of the preferred embodiments when read in conjunction with the accompanying drawings in which:

FIGS. la-lb (Perspective View) depicts a vehicle having a roof panel in which an extendable roof rack system is housed having a door system that maintains the roof panel's contour when the roof rack is in the stored position.

FIGS. 2a-2c (Perspective View) depict the sequence in which an extendable roof rack system in accordance with FIGS. la-lb of the present invention is actuated.

FIGS. 3a-3b (Perspective View) depicts a vehicle having a roof panel in which an extendable roof rack system is housed, wherein each transverse bar has an upper surface contoured to maintain the roof panel's contour when the roof rack is in the stored position.

FIGS. 4a-4c (Perspective View) depict the sequence in which an extendable roof rack system in accordance with FIGS. 3a-3b of the present invention is actuated.

FIG. 5 (Perspective View) depicts one embodiment of the vertically extending stanchions of the present invention.

FIGS. 6a-6e (Perspective View) depict some embodiments of the engagement of the tower structure of the vertically extending stanchion to the transverse bar of the extendable roof rack system in accordance with the present invention.

FIGS. 7a-7b (Perspective View) depict a vertically extending stanchion having a tower sway support.

FIG. 8 (Perspective View) depicts one embodiment of a vehicle having an extendable roof rack system with telescoping vertically extending towers and detachable transverse bars.

FIG. 9 (Perspective View) depicts one embodiment of a cable system for actuating the extendable roof rack system of the present invention.

FIG. 10 (Perspective View) depicts one embodiment of a modular extendable roof rack system in accordance with the present invention including storage provisions.

### DETAILED DESCRIPTION OF PREFERRED EMBODIMENTS

The present invention is now discussed in more detail referring to the drawings that accompany the present application. In the accompanying drawings, like and/or corresponding elements are referred to by like reference numbers.

Referring to FIGS. la and lb, a vehicle is depicted having a roof panel in which a roof rack system 100 is housed, wherein the contour 3 of the upper surface of the roof panel is maintained by doors 1 that are positioned to cover the roof rack system when in the stored position. The roof rack system includes a forward transverse bar 5 and a rear transverse bar 6 for supporting cargo. The forward transverse bar 5 is extended above the upper surface of the roof panel by at least two forward vertically extending stanchions 15 when in the deployed position, and is retracted below the upper surface of the roof panel into a forward transverse channel when in the stored position. The rear transverse bar 6 is extended above the upper surface of the roof panel by at least two rear vertically extending stanchions 16 when in the deployed position, and is retracted below the upper surface of the roof panel into a rear transverse channel when in the stored position.

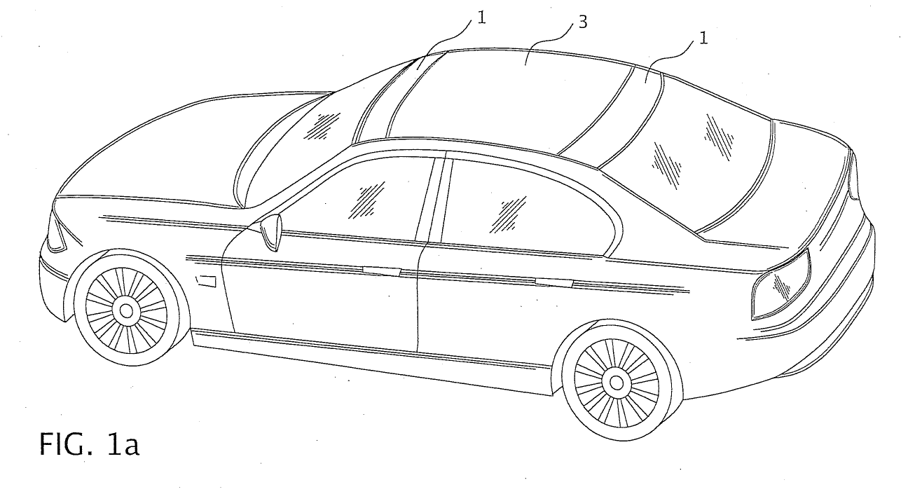

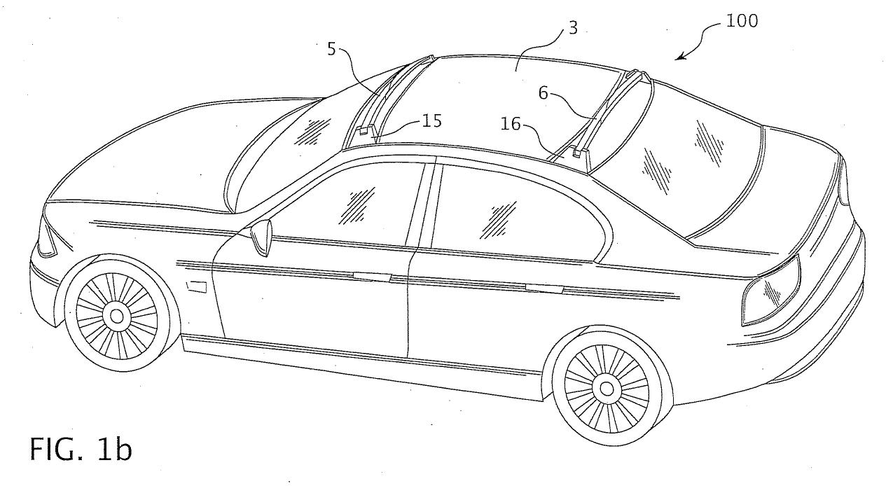

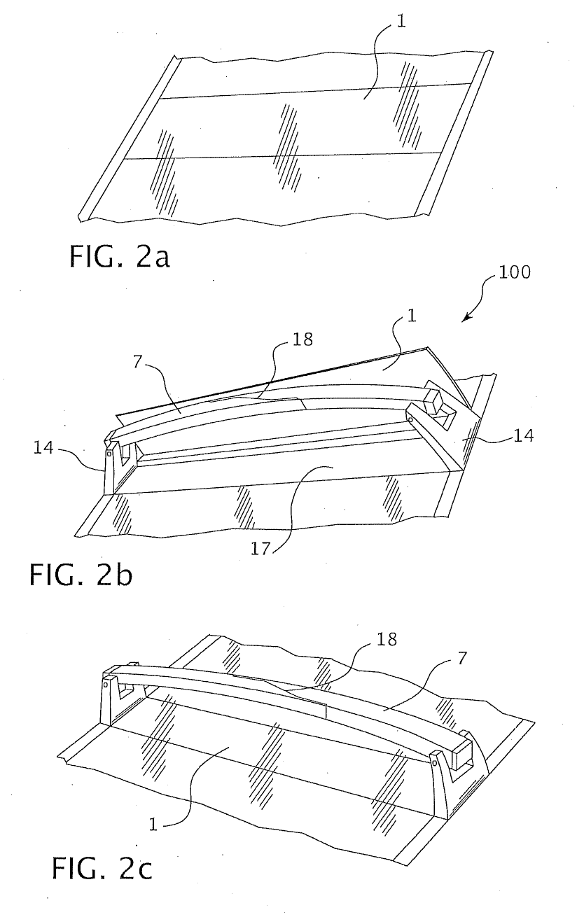

The sequence in which the roof rack system depicted in FIGS. la and lb operates is now described with reference to FIGS. 2a-2c. It is noted that although FIGS. 2a-2c depict only a single transverse bar, the following discussion is equally applicable to the actuation of forward transverse bar 5 and the rear transverse bar 6. It is further noted that for the purposes of simplicity in describing FIGS. 2a-2c, the at least two forward vertically extending stanchions 15 and the at least two rear vertically extending stanchions 16 are collectively referred to as vertically extending stanchions 14, and the forward transverse bar 5 and rear transverse bar 6 are collectively referred to as transverse bar 7.

Referring to FIG. 2a, when in the stored position the contour 3 of the roof panel is maintained by a forward door 1 that corresponds to the forward transverse bar and a rear door 1 that corresponds to the rear transverse bar. The forward and rear doors 1 may be engaged to the roof panel by hinged attachment.

Referring to FIG. 2b, in a first step the forward and rear door 1 are opened to expose the forward and rear transverse bars 7 that are positioned within the forward and rear transverse channels 17 and the vertically extending stanchions 14. In a next step, the vertically extending stanchions 14 are pivoted into a deployed position. Each vertically extending stanchion 14 is in pivoting engagement with a corresponding transverse bar 7.

In one embodiment, the pivoting engagement includes a transverse bar 7 having an elongated slot disposed along a portion of the transverse bar's length and the vertically extending stanchion 14 includes a pin that is slideably engaged within the slot. In this embodiment, the overall length of the transverse bar 7 may be fixed and the length of the slot may be selected to allow for the pin to slide from a first interior position, when the transverse bar is in a stored position, to a second exterior position, when the transverse bar is in the deployed position.

Still referring to FIG. 2b, in one embodiment, the pivoting engagement comprise a transverse bar 7 having in fixed pivoting engagement with the pin of the vertically extending stanchion 14. In this embodiment, the transverse bar may include a telescoping structure 18, wherein the transverse bar 7 is stored at a first length and extends by telescoping to a second length when in a deployed position.

Referring to FIG. 2c, following the extension of the vertically extending stanchions 14 and the corresponding forward and rear transverse bars 7, the doors 1 may be returned to their closed position. It is noted that the sequence is reversed to return the roof rack 100 from the deployed position to the stored position.

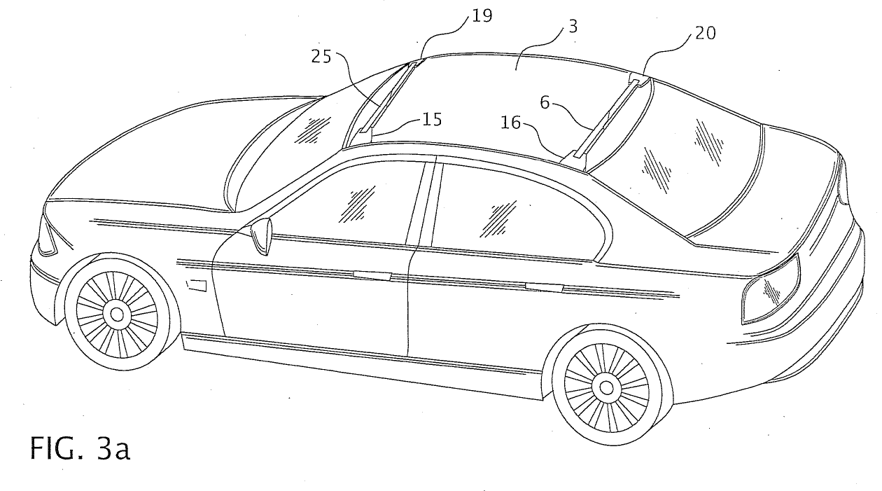

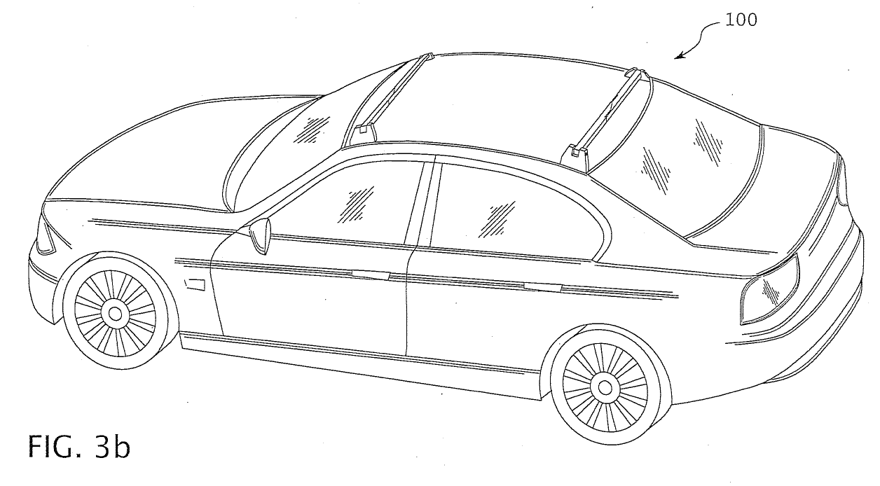

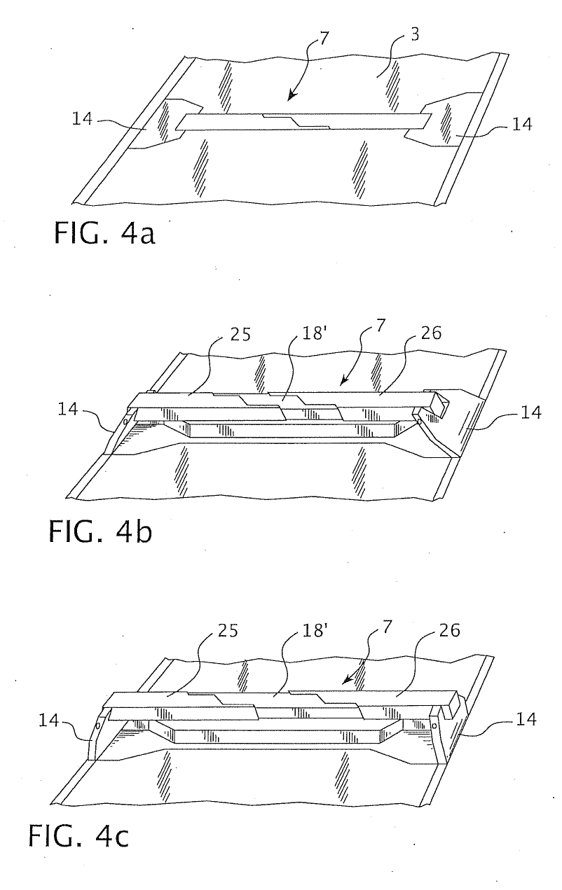

Referring to FIGS. 3a and 3b, in another embodiment of the present invention, the doors 1 may be omitted, wherein the contour 3 of the roof panel is maintained by the forward transverse bar's upper surface 19, the rear transverse bar's upper surface 20, and the exterior surfaces of the vertically extending stanchions 15, 16 when the roof rack system is in the stored position. The actuation of the roof rack system depicted in FIGS. 3a and 3b, is illustrated in FIGS. 4a-4c. It is noted that although FIGS. 4a-4c depict only a single transverse bar, the following discussion is equally applicable to the actuation of forward transverse bar 5 and the rear transverse bar 6. It is further noted that for the purposes of simplicity in describing FIGS. 4a-4c, the at least two forward vertically extending stanchions 15 and the at least two rear vertically extending stanchions 16 are collectively referred to as vertically extending stanchions 14, and the forward transverse bar 5 and rear transverse bar are collectively referred to as transverse bar 7.

Referring to FIG. 4a, when in the stored position the contour 3 of the roof panel is maintained by forward transverse bar's upper surface, the rear transverse bar's upper surface, and the exterior surfaces of the vertically extending stanchions 14. Referring to FIG. 4b, in a next sequence step the forward and rear transverse bars 7 are extended from their corresponding forward and rear transverse channels. It is noted that the engagement of the vertically extending stanchion 14 to transverse bars 7 in FIGS. 4a-4c is similar to the engagement of the vertically extending stanchion 14 to the transverse bars 7 in the embodiment depicted in FIGS. 2a-2c.

Still referring to FIG. 4b, in one embodiment of the present invention, the transverse bar 7 may include a telescoping structure 18′, wherein the transverse bar 7 having an upper surface aligned to the contour 3 of the roof panel employs a telescoping means similar to that described with reference to FIG. 2b. In one embodiment of the present invention, the telescoping transverse bars 7 may include at least two upper surfaces 25, 26, which allow for the transverse bar to be extended to a deployed length in the deployed position and provides a contoured surface that maintains the roof panel's contour 3 when the roof rack is in a stored position. Referring to FIG. 4c, the roof rack having transverse bars with upper surfaces 25, 26 is depicted in the deployed position.

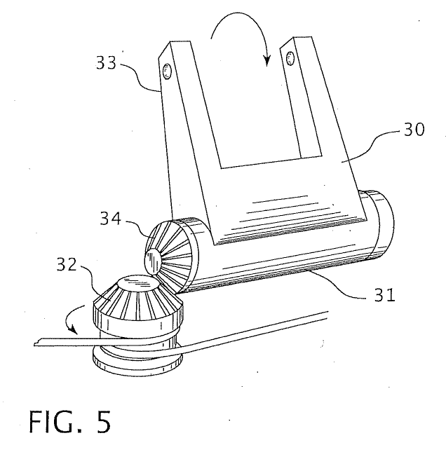

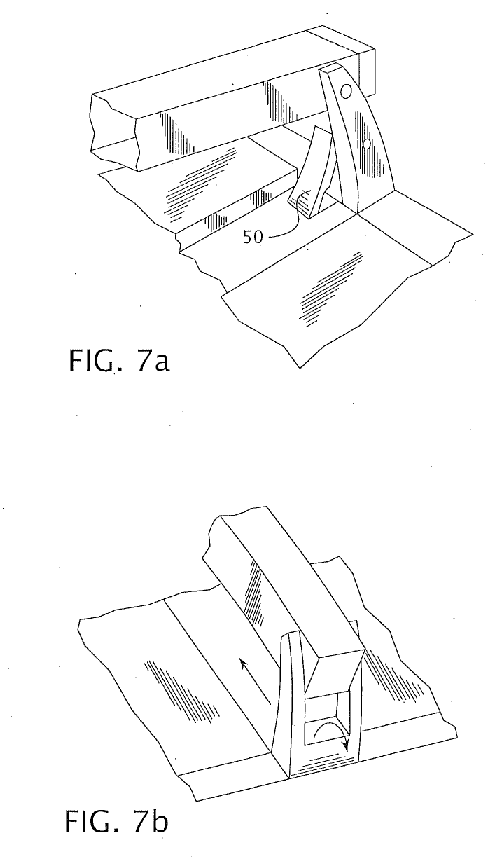

Referring to FIG. 5, in one embodiment of the present invention, the vertically extending stanchions 14, 15, 16 may comprise a tower structure 30 having a base 31 and an engagement end 33 that provides pivoting engagement to a transverse bar. The base 31 of the tower structure 30 may further comprise a pivot gear 34 that intermeshes with a drive gear 32. The drive gear 32 is in communication to a motor means (not shown). In one example, communication is provided by a cable 32. Alternatively, communication maybe provided by a chain or equivalent. In operation, the motor produces rotational motion at the drive gear 32. The drive gear 32 is in communication with the pivot gear 34 positioned at the base of the tower structure. Therefore, the rotational motion of the drive gear 32 actuates the pivot gear 34, which in turn vertically translates the shock tower 30 by pivoted motion at a hinged engagement to the roof panel. Hence, actuation of the motor provides rotational motion to each of the drive gears 32, wherein the rotational motion of the drive gears 32 is converted to translational motion in the tower structure 30 by the pivot gears 34. Referring to FIG. 7, in one embodiment of the present invention, a tower sway support 50 provides greater rigidity to the vertically extending stanchions 14, 15, 16 when in the deployed position, wherein the tower sway support 50 is recessed within the roof panel when in the stored position.

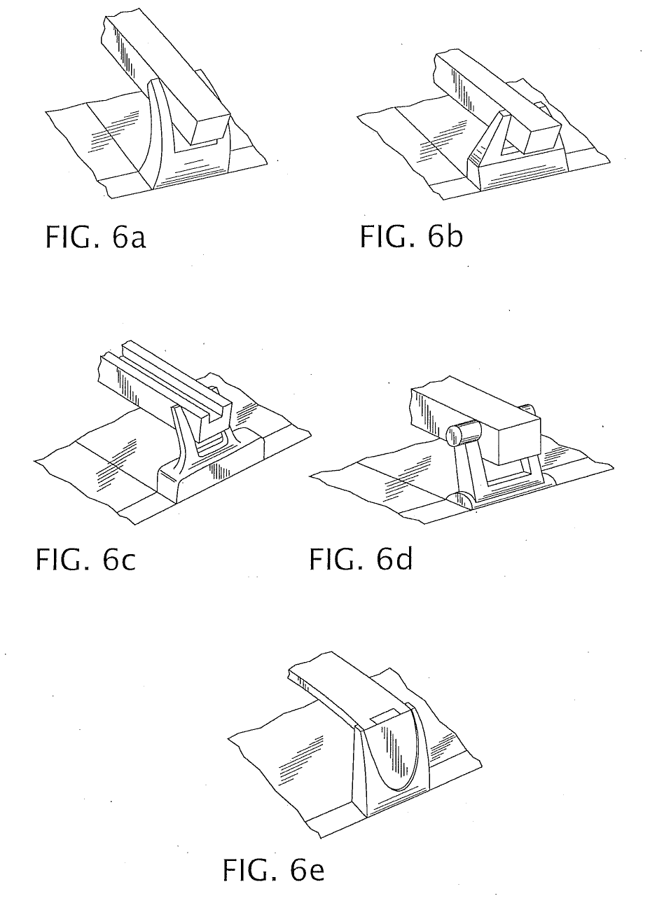

It is noted that any number of geometries may be utilized for a tower structure 30, so long as the geometry provides for pivoting engagement to a transverse bar. Examples of tower structure geometries and corresponding transverse bar engagement portions are depicted in FIGS. 6a-6e. It is noted that the examples depicted in FIGS. 6a-6e are provided for illustrative purposes only, and that the present invention is not deemed limited thereto.

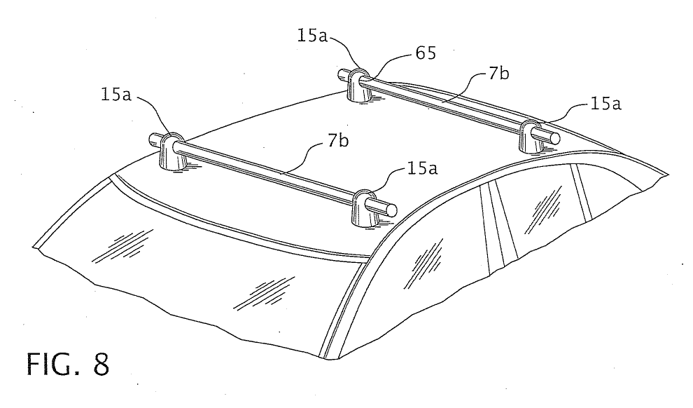

FIG. 8 depicts another embodiment of a roof rack system in accordance with the present invention, in which the vertically extending stanchions 15a are extended above the upper surface of the roof panel when in the deployed position, and are retracted below the upper surface of the roof panel when in the stored position. As opposed to the embodiments of the present invention including a transverse channel for housing the transverse bars, as depicted in FIGS. 1-4, in this embodiment the transverse bars 7a, 7b for supporting cargo are detachable. More specifically, the transverse bars 7a may be inserted into the vertically extending stanchions 15a when in the deployed position, most preferably inserted into eyelets 65 positioned in an upper portion of the vertically extending stanchions 15a. The transverse bars 7a, 7b may have a fixed length or may have an adjustable length, preferably adjustable by a telescoping mechanism. FIG. 8 depicts a forward transverse bar 7a in the deployed position and a partially installed rear transverse bar 7b. Preferably, the vertically extending stanchions 15a extend by a telescoping mechanism from at least two forward recesses and at least two rear recesses within the roof panel.

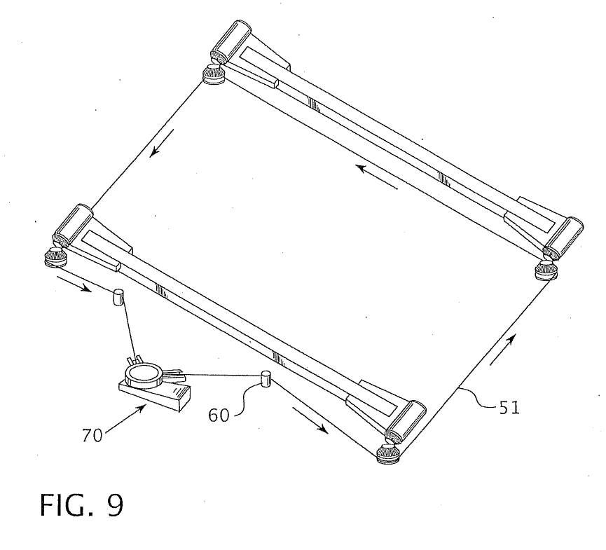

Referring to FIG. 9, in one embodiment of the present invention, each vertically extending stanchion may be connected by a communicating means 51 to a motor means 70. In a preferred embodiment, the motor means 70 includes an electrical motor. Alternatively, the motor means may comprise pneumatic or hydraulic motors, or may be manually activated. In operation, the communicating means may substantially simultaneously actuate each vertically extending stanchion. In one embodiment, the communicating means 51 may comprise an endless cable or equivalent structure that is engaged to the motor means 70. In one embodiment, the communicating means may be encased in a protective sheath. Additionally, guide rollers 60 may be employed to direct the communicating means to the vertically extending stanchions.

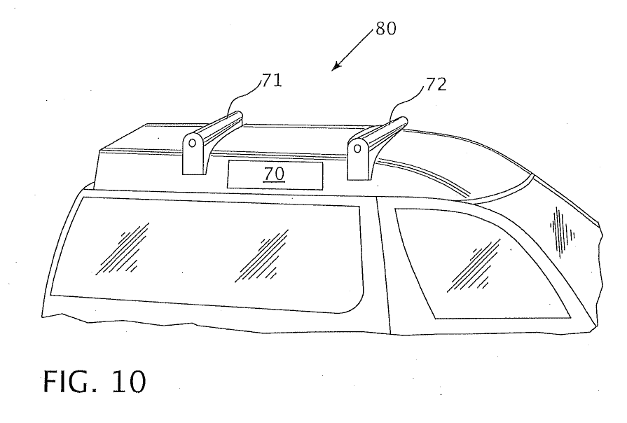

In each of the above embodiments the roof rack system may be integrated into the roof panel of the vehicle as a modular assembly. The modular assembly may also be integrated into other roof panel systems, such as moon roof and sun roof systems. In one embodiment, a modular system 80 in addition to including vertical extending stanchions and cargo bearing transverse bars 71, 72 may also include increased storage capacity by integrating storage compartments 70 within the modular assembly, as depicted in FIG. 10.

While illustrative embodiments of the invention are disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1. A roof rack comprising:
at least two forward recesses and at least two rear recesses within a roof panel;
a vertically extending stanchion in each of said at least two forward recesses and said at least two rear recesses;
a forward transverse channel starting at one forward recess and ending at an opposite forward recess of said at least two forward recesses;
a forward transverse bar extendably positioned in said forward transverse channel having pivoting connections with said vertically extending stanchions in said at least two forward recesses;
a rear transverse channel starting at one rearward recess and ending at an opposite rearward recess of said at least two rear recesses; and
a rear transverse bar extendably positioned in said rear transverse channel having pivoting connections with said vertically extending stanchions in each of said at least two rear recesses, wherein said each of said rear transverse bar and said forward transverse bar having a stored position with a vertical height below an upper surface of said roof panel and a deployed position above said upper surface of said roof panel.

2. The roof rack of claim 1 wherein each of said forward transverse bar and said rear transverse bar are constructed of a telescoping assembly that extends to a first length when said roof rack is in said deployed position and retracts to a second length when said roof rack is in said stored position.

3. The roof rack of claim 1 wherein said forward transverse bar and said rear transverse bar have an upper surface that is aligned to a contour of said upper surface of said roof panel when said forward transverse bar and said rear transverse bar are in said stored position.

4. The roof rack of claim 1, further comprising at least one cover for each of said forward transverse channel and said at least two forward recesses and said rear transverse channel and said at least two rear recesses, wherein each of said at least one cover is aligned to a contour of said upper surface of said roof panel when forward transverse bar and said rear transverse bar are in said stored position.

5. The roof rack of claim 4, wherein each of said at least one cover is in hinge attachment to said roof panel.

6. The roof rack of claim 1, wherein said vertically extending stanchions further comprise a telescoping extension.

7. The roof rack of claim 1, wherein said vertically extending stanchions comprise a hinged pivoting extension.

8. The roof rack of claim 1, wherein said vertically extending stanchions may be actuated from said stored position to said deployed position by pneumatic, hydraulic, or electrical motors.

9. The roof rack of claim 1, wherein said vertically extending stanchions may be actuated manually.

10. The roof rack of claim 1 wherein each of said vertically extending stanchions comprises a tower structure having a hinged pivoting extension and a drive gear, each of said tower structure comprises a pivot gear positioned in a base portion of said tower structure and intermeshed with said drive gear corresponding to said tower structure.

11. The roof rack of claim 10 wherein each of said drive gears of said vertically extending stanchions are in communication with a motor, wherein actuation of said motor provides rotational motion to each of said drive gears, wherein said rotational motion of each of said drive gears is converted to translational motion in said tower structure by said pivot gear.

12. The roof rack of claim 10 wherein said translational motion comprises pivoting of said tower structure from said stored position to said deployed position and pivoting of said tower structure from said deployed position to said stored position.

13. The roof rack of claim 11 wherein said communication between each of said drive gears is provided by an endless cable engaged to each of said drive gears and said motor.

14. The roof rack of claim 13 wherein said cable is covered by a sheath.

15. The roof rack of claim 1, wherein said forward transverse bar and said rear transverse bar comprise extruded aluminum.

16. The roof rack of claim 1 wherein said at least two forward recesses and said forward transverse channel comprise a unitary forward channel; and said at least two rear recesses and said rear transverse channel comprise a unitary rear channel.

17. The roof rack of claim 1 wherein said roof rack is integrated into a modular assembly including storage compartments.

18. A roof rack comprising:
at least two forward recesses and at least two rear recesses within a roof panel;
a vertically extending stanchion in each of said at least two forward recesses and said at least two rear recesses; wherein said each of said vertically extending stanchions having a stored position with a vertical height below an upper surface of said roof panel and a deployed position above said upper surface of said roof panel;
a forward transverse bar detachably connected to the vertically extending stanchions in the at least two forward recesses when in the deployed position; and
a rear transverse bar detachably connected to the vertically extending stanchions in the at least two rear recesses when in the deployed position.

19. The roof rack of claim 18, wherein the forward transverse bar and the rear transverse bar have a fixed or adjustable length.

20. The roof rack of claim 18 wherein the vertically extending stanchions extend by a telescoping mechanism.
